(19) United States
(12) Patent Application Publication
(10) Pub. No.: US 2015/0148937 A1
(43) Pub. Date: May 28, 2015

(54) ARRANGEMENT WITH A HAND-GUIDED MACHINE TOOL AND A GRINDER

(71) Applicant: RHODIUS SCHLEIFWERKZEUGE GMBH & CO. KG, BURGBROHL (DE)

(72) Inventor: MIKE WOLF, OSNABRUECK (DE)

(21) Appl. No.: 14/555,707

(22) Filed: Nov. 28, 2014

(30) Foreign Application Priority Data
Nov. 28, 2013 (DE) 10 2013 113 202.2

(51) Int. Cl. G05B 15/00; B24B 23/02

(52) U.S. Cl. CPC G05B 15/00; B24B 23/028
USPC 700/164; 451/359

(57) ABSTRACT

An arrangement includes a grinding wheel and a hand-held power tool. The hand-held power tool comprises a housing, a drive shaft, a drive unit configured to drive the drive shaft, a first handle and a second handle which are each fixed on the housing, a sensor, and an evaluation and control device. The sensor is configured to record at least one property information of the grinding wheel so as to determine a diameter of the grinding wheel. The evaluation and control device is configured to generate a setpoint value for a rotational speed based on the at least one property information of the grinding wheel recorded.

### CROSS REFERENCE TO PRIOR APPLICATIONS

Priority is claimed to German Patent Application No. DE 10 2013 113 202.2, filed Nov. 28, 2013. The entire disclosure of said application is incorporated by reference herein.

### FIELD

The present invention relates to an arrangement with a hand-held power tool and a grinding wheel, in particular a cutting-off wheel or a roughing wheel.

### BACKGROUND

Workpieces can be machined with such an arrangement. A cutting-off wheel or a roughing wheel is fastened to the power tool for this purpose, in particular an angle grinder. A defined optimum rotational speed for each respective wheel exists at which the wheel should be operated. This optimum rotational speed is determined from an optimum circumferential speed and the diameter of the grinding wheel. It has until now been assumed that the ideal situation of a wheel diameter is one that remains constant. In practice, however, after a certain amount of wear, and an accompanying reduction in diameter, the optimum circumferential speed is no longer achieved in spite of the rotational speed having been correctly set.

This fundamental problem has previously been addressed. DD 142 308, for example, a switching arrangement for controlling the circumferential speed of a grinding wheel. The reduction in diameter of the grinding wheel that accompanies use is recorded on the basis of a position of a water nozzle adjustment that serves for cooling. The control of the circumferential speed is thus coupled with the water nozzle adjustment. This method is not, however, suitable for hand-held power tools since they do not have a water nozzle adjustment. DD 104 745 A1 also a solution to compensate for the diameter of the grinding wheel which, while applicable to stationary power tools, cannot be applied to hand-held power tools such as angle grinders.

### SUMMARY

An aspect of the present invention is to apply a control of the circumferential speed that also considers the wear of grinding wheels to hand-held power tools, in particular to angle grinders.

In an embodiment, the present invention provides an arrangement which includes a grinding wheel and a hand-held power tool. The hand-held power tool comprises a housing, a drive shaft configured to be mounted on the housing via a bearing, a drive unit configured to drive the drive shaft, a first handle and a second handle which are each fixed on the housing, a fastening device configured to fasten the grinding wheel to the drive shaft, a sensor, and an evaluation and control device. The sensor is configured to record at least one property information of the grinding wheel so as to determine a diameter of the grinding wheel. The evaluation and control device is configured to generate a setpoint value for a rotational speed based on the at least one property information of the grinding wheel recorded.

### BRIEF DESCRIPTION OF THE DRAWINGS

The present invention is described in greater detail below on the basis of embodiments and of the drawings in which:

FIG. 1 shows a commercially available power tool with a fitted grinding wheel;

FIG. 2 schematically shows the structure of an arrangement according to the present invention in a first configuration a) with a new grinding wheel, and b) with a worn grinding wheel;

FIG. 3 shows a grinding wheel with a printed-on two-dimensional marking a) in the new state, and b) in the worn state.

### DETAILED DESCRIPTION

The present invention provides that the grinding wheel itself is recorded by sensors, and that one or more properties of the wheel thereby recorded are used to determine the diameter of the wheel at any given time. The diameter of the wheel thereby determined can be used in a known way to calculate the optimum rotational speed, i.e., the setpoint value for the rotational speed. In contrast to known methods, it is not the case that a manipulated variable of the stationary power tool that is only obtained indirectly from the reduction in diameter is used to determine the diameter of the wheel at the time. The wheel itself is much rather investigated for properties that the wheel bears within or on itself to draw the required conclusions on the diameter of the wheel or the wear. The sensor system is consequently aimed directly at the wheel and not at the parts of the power tool (for example, a water nozzle adjustment) as in previously-described solutions.

In an embodiment of the present invention, an optical sensor, for example, a light scanner or an image acquisition unit, can be provided as the sensor means. Such a sensor can determine the position of an outer contour of the grinding wheel and thereby act, for example, in a way similar to a light barrier. The relative position of the outer contour with respect to the sensor and the relative position of the sensor with respect to the axis of rotation can then be used to determine the diameter of the wheel. A more or less complex image acquisition may, however, also be provided to record one or more photographs of regions of the grinding wheel from which the diameter of the wheel is determined.

It is not, however, in principal necessary that the diameter at any given time be explicitly calculated and provided as a value. It is sufficient if the reduction in diameter can be derived from the determined property of the wheel.

In an embodiment of the present invention, a coded marking, for example, an optically recordable marking which changes as a result of a reduction in diameter, can, for example, be provided on the wheel as a property of the wheel that is recorded by the sensor. The marking may comprise a number of constituent parts which are provided at different respective radial positions of the wheel. Through wear of the wheel, in particular on account of the wheel being used in the manner intended, the radially outer lying constituent parts of the marking then disappear along with the wheel. All that remains are the constituent parts of the marking in the inner-lying radial regions. The disappearance of the outer-lying constituent parts has the effect that the marking itself changes in its overall state, which in turn makes it possible to determine the diameter of the wheel.

Such an optically recordable marking may be applied on the grinding wheel in a two-dimensional and/or a three-dimensional form. An example of a two-dimensional marking is a radially directed barcode. A three-dimensional marking may also be formed by a barcode. The bars of the code are additionally present at different axial positions. The bars are then located at different positions in height with respect to the plane of the wheel. A relief is thus created on the surface of the grinding wheel.

The diameter is not only significant to calculate, or ascertain in some other manner, the optimum rotational speed. The different respective types of grinding wheels are generally assigned a respective optimum speed value which must be taken as a basis for the calculation. It is possible that a user input the rated rotational speed. The rated rotational speed is, for example, understood to man the optimum rotational speed mentioned specified by the manufacturer. This rotational speed to be applied in particular for as-new wheels. If it is then found from the determined properties of the wheel that the diameter of the wheel has been reduced due to wear, the control of the type described above increases the setpoint rotational speed of the tool according to requirements on the basis of the rated rotational speed.

In an embodiment of the present invention, the type of grinding wheel fitted can, for example, be determined on the basis of a sensor. The type thus determined is then taken into account in determining the diameter and/or the setpoint rotational speed. It is in particular suitable in this case that a barcode applied on the wheel is, for example, recorded by an optical sensor. This code can unequivocally identify the wheel according to its type. A memory unit of the power tool may assign a respective rated rotational speed to different types of grinding wheels. The identification of the type of grinding wheel can, for example, be accomplished with this code, with the determination of the wear or reduction in diameter being carried out as described above.

In an embodiment of the present invention, the power tool can, for example, comprise a rotational speed control which provides that the drive shaft rotates in a way corresponding to the setpoint value for the rotational speed, for example, even when the wheel is slowed down upon being subjected to a great load exerted by the grinding wheel.

The present invention is explained in more detail below on the basis of the drawings.

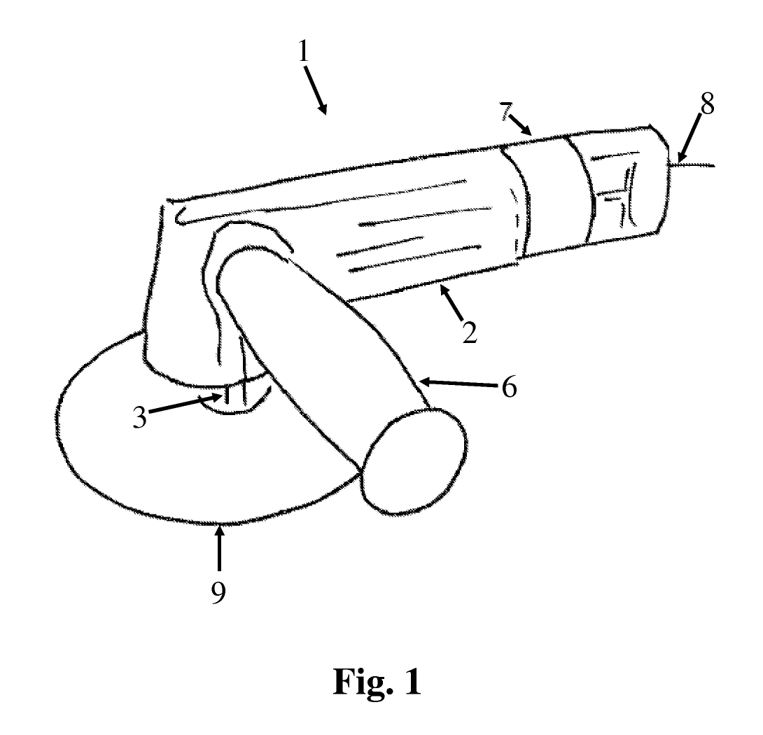

FIG. 1 shows a known power tool 1 in the form of an angle grinder. This comprises a housing 2 with first handle 6 and second handle 7, at which an operator holds the power tool 1 with both hands during a working operation. The power tool 1 also has a drive shaft 3, which is mounted in the housing 2 via a bearing (not shown in the drawings). Fastened to the drive shaft 3 is a grinding wheel or roughing wheel 9. The grinding wheel can be fastened to the drive shaft via a fastening device (not shown in the drawings). The power tool 1 receives electrical energy by way of a power lead 8. Such a power tool may, however, also be driven by a different energy source, for example, pneumatically or hydraulically. The term housing should be understood broadly and may also comprise internal supporting structures of the power tool.

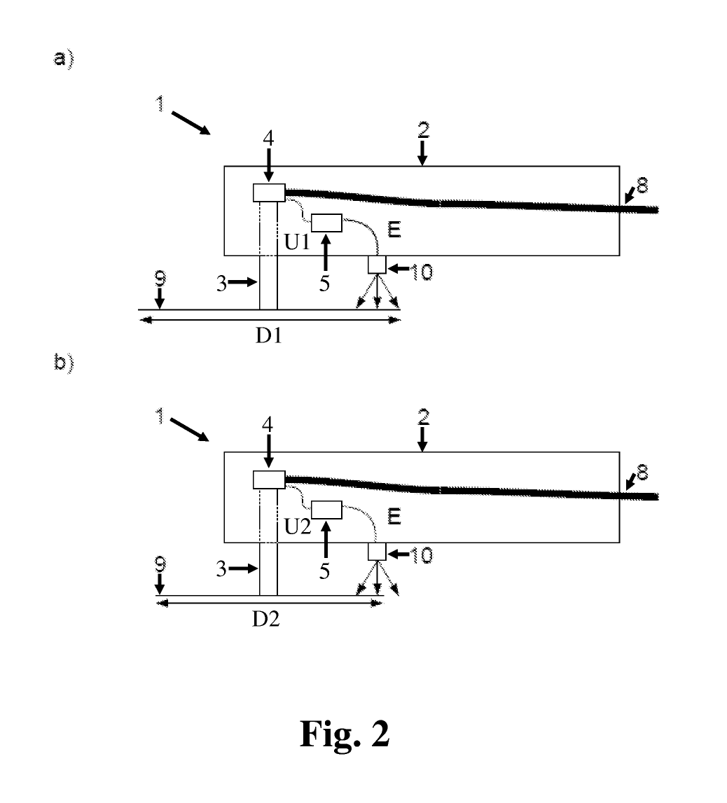

FIG. 2 shows the schematic structure of an arrangement according to the present invention in a first configuration with a power tool 1, it being possible for the power tool 1 used to be constructed largely on the basis of the known angle grinder 1 as shown in FIG. 1. A drive motor 4 is shown which is supplied with electrical energy by way of the power lead 8, and which drives the drive shaft 3 and the grinding wheel 9 fitted thereon at a predetermined rotational speed U1. Grinding wheels, in particular cutting-off wheels and roughing wheels, are generally optimized for a specific rotational speed, i.e., the rated rotational speed. Although the optimum operating state is usually specified in the unit “rotational speed”, this is obtained from an optimum circumferential speed, which is measured at the outer circumference of the wheel. If the diameter of the grinding wheel 9 changes, the optimum rotational speed at which the grinding wheel can be used therefore also changes. This has to date not been considered in angle grinders and the like.

The drive unit 4 is controlled by an evaluation and control unit 5. The evaluation and control unit 5 outputs a setpoint value for the setback rotational speed U2 to the drive unit 4. The drive unit 4 comprises a rotational speed control, which provides that the drive shaft 4 rotates at the setpoint value for the rotational speed irrespective of any changes in load. The determination of the setpoint rotational speed U2 is therefore decisively influenced by a sensor 10 which records a property information of the grinding wheel E. In the shown embodiment, the sensor 10 is an optical sensor which scans the outer contour of the grinding wheel 9 in the manner of a light scanner. FIG. 2a) shows the grinding wheel 9 in a new state. All of the rays of light that are emitted by the optical sensor 10 impact/impinge on the grinding wheel 9. All of the rays of light are also reflected back and are detected by the sensor 10. The sensor 10 therefore essentially detects the complete grinding wheel 9. There is therefore no wear at the outer circumference. An adaptation of the rotational speed is not yet required.

FIG. 2b) shows that the diameter D2 of the grinding wheel 9 has been reduced compared to the diameter D1 of the grinding wheel 9 in FIG. 2a). The rays of light no longer all impact/impinge on the grinding wheel 9, and can thus no longer be reflected thereby. Sensor 10 consequently detects that the outer contour of grinding wheel 9 is now arranged further inward. This corresponding property information of the grinding wheel E is then output to the evaluation and control unit 5, which performs the evaluation. Evaluation and control unit 5 then outputs an increased setpoint rotational speed U2 to the drive unit 4 so that the circumferential speed is again set to an optimum value. The circumferential speed at the outer circumference of the grinding wheel 9 thus remains constant in spite of wear.

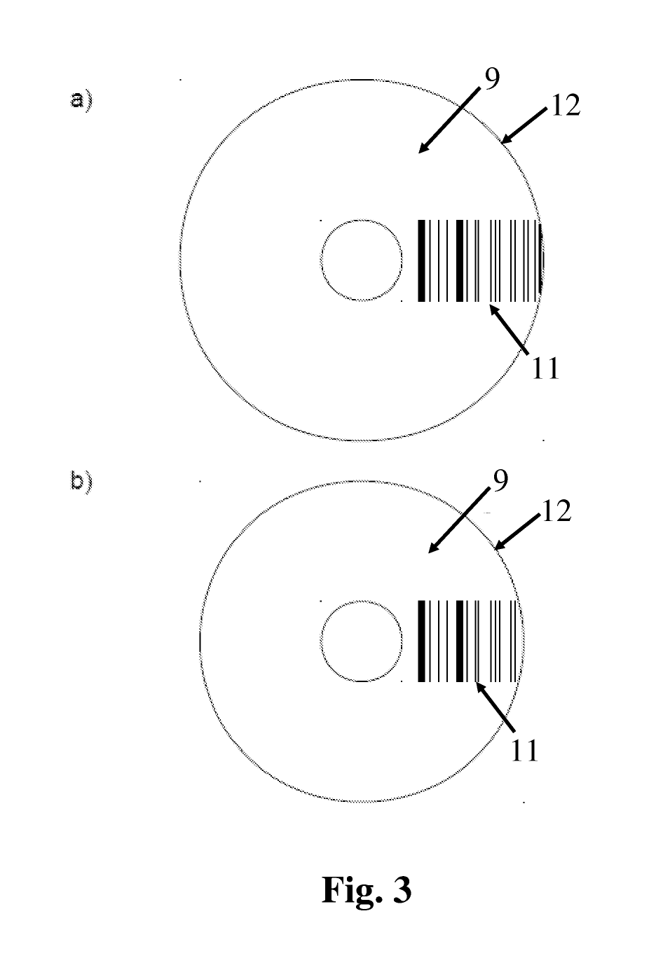

FIG. 3 shows a possible marking on the grinding wheel 9 which can be detected by an optical sensor, such as, for example, as also shown in FIG. 2. The grinding wheel 9 has a barcode 11 which extends radially from the inside outward. Barcode 11 thereby extends up to the circumferential edge 12. FIG. 3a) shows a new grinding wheel 9. FIG. 3b) shows a worn grinding wheel 9 on which the diameter has been reduced. The outermost bars of the barcode 11 on the worn grinding wheel 9 have disappeared along with the outer regions of the grinding wheel 9. A barcode 11′ that has changed overall is thereby obtained which can be detected by the optical sensor 10 and which can correspondingly be evaluated.

The type of grinding wheel 9 can furthermore be determined via the barcode 11 as shown in FIG. 3. How the changes of the properties of the grinding wheel 9 are to be converted into a change of the rotational speed can then be stored in a memory unit of the power tool (not shown in the drawings).

The present invention is not limited to embodiments described herein; reference should be had to the appended claims.

### LIST OF REFERENCE NUMBERS

1 Power tool/Angle grinder

2 Housing

3 Drive shaft

4 Drive unit/Drive motor

5 Evaluation and control unit

6 First handle

7 Second handle

8 Power lead

9 Grinding wheel

10 Sensor/Optical sensor

11 Coded Marking/Barcode

12 Circumferential edge

D1 Diameter of a new grinding wheel

D2 Diameter of used grinding wheel

E Property information of the grinding wheel

U1 Predetermined rotational speed

U2 Setpoint rotational speed

What is claimed is:

1. An arrangement comprising:
a grinding wheel; and
a hand-held power tool comprising:
a housing;
a drive shaft;
a drive unit configured to drive the drive shaft;
a first handle and a second handle which are each fixed on the housing;
a sensor configured to record at least one property information of the grinding wheel so as to determine a diameter of the grinding wheel; and
an evaluation and control device configured to generate a setpoint value for a rotational speed based on the at least one property information of the grinding wheel recorded.

2. The arrangement as recited in claim 1, wherein the hand-held power tool is an angle grinder.

3. The arrangement as recited in claim 1, wherein the sensor is an optical sensor.

4. The arrangement as recited in claim 3, wherein the optical sensor is a light scanner or an image acquisition unit.

5. The arrangement as recited in claim 1, wherein the at least one property information of the grinding wheel is a coded marking provided on the grinding wheel, the coded marking being configured to change when the diameter of the grinding wheel is reduced.

6. The arrangement as recited in claim 5, wherein the coded marking is an optically recordable marking.

7. The arrangement as recited in claim 6, wherein the optically recordable marking is provided on the grinding wheel in a two-dimensional form.

8. A method for controlling a rotational speed of an arrangement comprising:
a grinding wheel; and
a hand-held power tool comprising:
a housing;
a drive shaft configured to be mounted on the housing via a bearing;
a drive unit configured to drive the drive shaft;
a first handle and a second handle which are each fixed on the housing;
a sensor configured to record at least one property information of the grinding wheel so as to determine a diameter of the grinding wheel; and
an evaluation and control device configured to generate a setpoint value for a setback rotational speed based on the at least one property information of the grinding wheel recorded.
the method comprising:
recording the at least one property information of the grinding wheel with the sensor with which the diameter of the grinding wheel at a time can be determined; and
generating the setpoint value for the setback rotational speed with the evaluation and control device based on the at least one property information of the grinding wheel recorded.

9. The method as recited in claim 8, wherein the at least one property information of the wheel is taken directly from the grinding wheel.

10. The method as recited in claim 8, wherein the sensor is an optical sensor, the at least one property information of the grinding wheel is an outer contour of the grinding wheel, and the outer contour is recorded with the optical sensor.

11. The method as recited in claim 8, wherein the at least one property information of the wheel is a marking applied to the grinding wheel which is configured to change in based on a wear of the grinding wheel, and the marking is recorded with the sensor.

12. The method as recited in claim 11, wherein the marking is a barcode.

13. The method as recited in claim 8, further comprising
accounting for a user input when the diameter of the grinding wheel is determined and/or when generating the setpoint rotational speed.

14. The method as recited in claim 8, further comprising
determining a type of the grinding wheel with the sensor; and
taking the type of the grinding wheel determined into account when the diameter of the grinding wheel is determined and/or when generating the setpoint rotational speed.
